(19) United States
(12) Patent Application Publication
(10) Pub. No.: US 2007/0024150 A1
(43) Pub. Date: Feb. 1, 2007

(54) Electrical machine having centrally disposed stator

(76) Inventors: Charles D. Syverson, North Mankato, MN (US); Christer Gotmalm, Hilton Beach (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/193,621

(22) Filed: Aug. 1, 2005

(51) Int. Cl. H02K 1/00; H02K 1/28

(52) U.S. Cl. 310/218; 310/216

(57) ABSTRACT

An electrical generator comprising a stator having stator windings and a rotor having rotor windings. The rotor and the rotor windings extend about the stator windings. The rotor includes an annular rotor housing. On an inside of the rotor housing are mounted the rotor windings. The stator includes an end member with a central member extending therefrom. The stator windings are mounted on the central member. The stator also includes an annular stator housing that extends about the central member, including the stator windings, and the rotor. The end member attaches to the stator housing thereby positioning the stator windings in a central location. The stator housing and the end member enclose the stator windings and the rotor windings therein. The rotor housing further includes a rotor mounting member on an end. The stator housing includes a stator mounting member on an end thereof, and a stator windings mounting member on an opposite end. The stator windings include an exciter field winding and a generator armature winding. The rotor windings include an exciter armature winding and a generator field winding. The exciter armature winding is disposed radially outwardly from and adjacent to the exciter field winding. The generator field winding is disposed radially outwardly from and adjacent to the exciter armature winding.

### BACKGROUND OF THE INVENTION

This invention relates to electrical machines having centrally disposed stators and, in particular, to electrical generators having centrally disposed stators.

Conventional electrical generators have made use of a permanent magnet to provide a DC magnetic field, such as disclosed in U.S. Pat. No. 4,900,959, issued Feb. 13, 1990 to Drinkut et al. This limits the usefulness of the electrical generator in many applications requiring the excited magnetic field to be controlled, which is not possible when using permanent magnets. As disclosed in Drinkut et al., conventional electrical generators further include a generator shaft and bearing to attach to the rotor for rotation. This complicates the mounting of the electrical generator on a rotational means, such as found on an engine. Additionally, these electrical generators have made use of DC current collection rings to route the generated power off of the rotor to be used by a load. This decreases the reliability and rotational speed of such generators.

### SUMMARY OF THE INVENTION

A first aspect of the present invention includes an electrical generator comprising a stator having stator windings, and a rotor having rotor windings. The rotor and the rotor windings extend about the stator windings. The rotor includes an annular rotor housing. On an inside of the rotor housing are mounted the rotor windings. The stator includes an end member with a central member extending therefrom. The stator windings are mounted on the central member. The stator also includes an annular stator housing that extends about the central member, including the stator windings, and the rotor. The end member attaches to the stator housing thereby positioning the stator windings in a central location. The stator housing and the end member enclose the stator windings and the rotor windings therein.

The rotor housing further includes a rotor mounting member at an end, which can be a flange extending radially inwardly from the rotor housing. The rotor mounting member is used to mount the rotor to a rotatable member.

The stator housing includes a stator mounting member at an end thereof, and a stator windings mounting member at an opposite end. The stator mounting member can be a flange extending radially outwardly from the stator housing, and the stator windings mounting member can be a flange extending radially inwardly from the stator housing.

The stator windings include an exciter field winding and a generator armature winding. The rotor windings include an exciter armature winding and a generator field winding. The exciter armature winding is disposed radially outwardly from and adjacent to the exciter field winding.

The generator field winding is disposed radially outwardly from and adjacent to the exciter armature winding. The generator field winding includes an annular core. The annular core includes an inside annular surface and a plurality of members, each said member having a first side, a second side and an end. The first side and the second side of each said member project radially inwardly from the inside annular surface towards the end. Each said member has a projection extending from the first side near the end. A coil is mounted on each said projection.

In a second aspect of the present invention the generator field winding includes an annular core with an inside annular surface and a side surface, the inside annular surface has a plurality of recesses. The generator field winding also includes a plurality of winding members. Each said winding member has a protrusion that is mutually engageable with each said recess. A coil is mounted on each said winding member. The winding member further includes a body member and a protrusion. The body member has a pair of sides and an end. The body member extends from the protrusion, along the pair of sides, towards the end. The projection extends from one of the pair of sides near the end. The coil is mounted on the projection.

In a third aspect of the present invention a method is provided to mount the electrical generator to an engine. The method comprises the steps of aligning a rotor having rotor windings and a rotor mounting member to a flywheel. Then, connecting the rotor mounting member to the flywheel. Next, connecting the stator housing having a stator mounting member and a stator windings mounting member to an engine block, the stator housing enclosing the rotor. Finally, connecting an end member to the stator windings mounting member, the end member having a central member with stator windings mounted thereon.

The inside-out geometry of the present embodiment provides many advantages. It allows for elimination of a generator shaft and generator bearing. The relatively large diameter of the rotor mounting member results in very good structural strength. This eliminates the need for an outboard support bearing, as is commonly known in the art, and permits a cantilevered design.

A high rotational inertia is also achieved with the inside-out geometry. This fulfills a need that exists when the generator is used on small diesel engines. Since the rotor lies radially outwardly of the stator windings, it has the necessary rotational inertia for small diesel engines without adding excessive weight.

Another advantage of the inside-out geometry is its thermal characteristic. The location of the generator field winding around an inner periphery of the rotor housing, next to the stator housing, provides significantly more cooling surface than if it was located radially within the stator windings. The generator field winding can expel its heat losses to the surrounding stator housing. Additionally, the inside-out geometry allows for air ventilation openings in the rotor to allow for some passive circulation of air in and around the rotor windings to provide cooling.

### BRIEF DESCRIPTION OF THE DRAWINGS

The present invention will be more readily understood from the following description of preferred embodiments thereof given, by way of example only, with reference to the accompanying drawings, in which:

FIG. 1 is an exploded isometric view of an electrical machine according to one embodiment of the present invention;

FIG. 2 is a cross-sectional view of the electrical machine of FIG. 1;

FIG. 3 is an end view of an exciter field winding, partially wound, having symmetric coil projections of the electrical machine of FIG. 1;

FIG. 4 is an end view of an exciter armature winding of the electrical machine of FIG. 1;

FIG. 5 is an end view of a generator field winding, partially wound, having asymmetric coil projections of the electrical machine of FIG. 1;

FIG. 6 is an end view of a generator armature winding of the electrical machine of FIG. 1;

FIG. 7 is an end view of a modular generator field winding according to another embodiment of the present invention.

FIG. 8 is a cross-sectional view of an electrical machine according to another embodiment of the present invention.

FIG. 9 is a view in perspective of a rotor of an electrical machine according to another embodiment of the present invention.

FIG. 10 is an end view of the rotor of the electrical machine of FIG. 9.

FIG. 11 is a view in cross-section taken along line A-A of the rotor of FIG. 9.

FIG. 12 is an exploded side view of a stator of the electrical machine of FIG. 9.

FIG. 13 is a side view of the stator of the electrical machine of FIG. 9.

FIG. 14 is an end view of the stator of the electrical machine of FIG. 9.

### DETAILED DESCRIPTION OF THE PREFERRED EMBODIMENTS

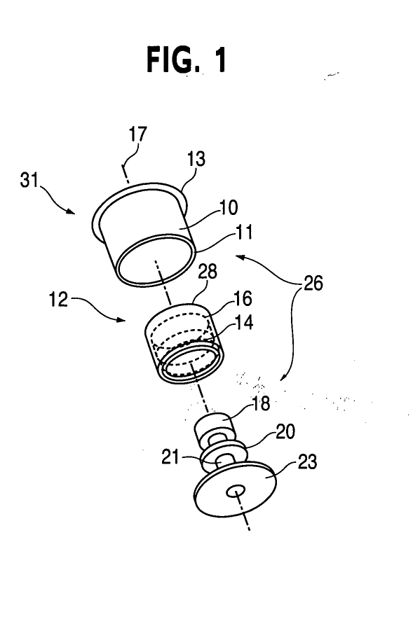

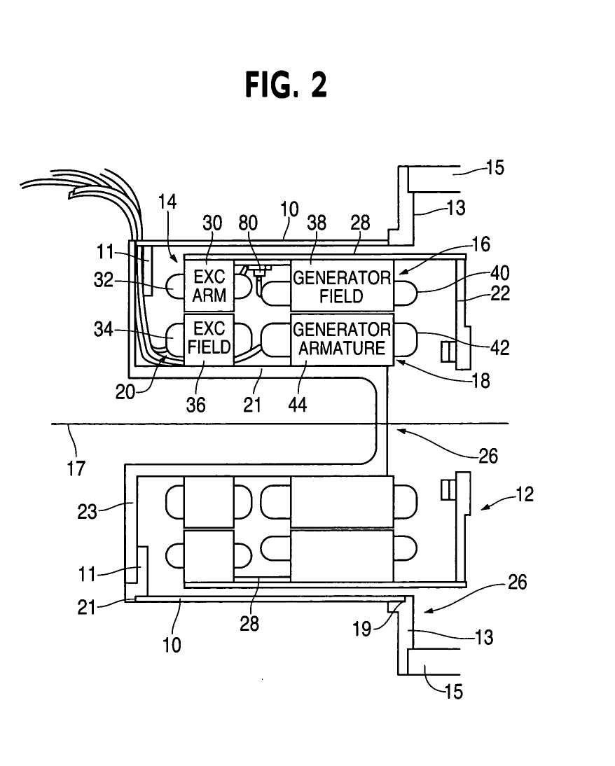

Referring to the drawings and first to FIG. 1, this shows a preferred embodiment of the present invention. An electrical generator 31 is illustrated with an inside-out geometry. The electrical generator 31 has a stator and an annular rotor indicated generally by reference numerals 26 and 12 respectively. The electrical generator 31 is a brushless generator in this example. The electrical generator 31 provides a DC voltage and a DC current to a load in this example, but in other embodiments the electrical generator may provide an AC voltage and an AC current to an AC load, or both AC and DC voltages and AC and DC currents may be provided to AC and DC loads respectively. The stator 26 has an exciter field winding 20 and a generator armature winding 18, collectively referred to as the stator windings, extending about an outer periphery of a central member 21. The central member 21 is attached to an end member 23 so as to centrally locate the stator windings 18 and 20 inside the rotor 12. The end member 23 is connected to a stator housing 10 that encloses the rotor 12 and the stator windings 18 and 20 as seen in FIG. 2. The rotor 12 comprises an exciter armature winding 14 and a generator field winding 16, collectively referred to as the rotor windings, on an inside of an annular rotor housing 28.

The alignment between the stator windings 18 and 20 and the rotor windings 14 and 16 is illustrated in FIG. 2. The exciter field winding 20 is adjacent to and disposed radially inwardly from the exciter armature winding 14. The exciter field winding 20 comprises an exciter field annular core 36 and a plurality of exciter field coils 34. The exciter field annular core 36 may comprise a solid core or may comprise a plurality of laminations. The exciter armature winding 14 comprises an exciter armature annular core 30 and a plurality of exciter armature coils 32. The exciter armature annular core 30 comprises a plurality of laminations in this example.

The exciter field winding 20 is excited by an exciter field current, for example a DC current from a battery or a DC current from a control system. In other embodiments the exciter field current may be a pulsed current or an AC current. The exciter field current flows through the exciter field coils 34, creating an exciter field magnetic field. The exciter armature coils 32 on the rotor 12 rotate through the exciter field magnetic field. This induces an exciter armature current to flow through the exciter armature coils 32. The exciter armature current is an AC current. [0017] The generator field winding 16 and the generator armature winding 18 are now described in greater detail. The generator field winding 16 is adjacent to and disposed radially outwardly from the generator armature winding 18. The generator field winding 16 comprises a generator field annular core 38 and a plurality of generator field coils 40. The generator field annular core 38 may comprise a solid core or may comprise a plurality of laminations. The generator armature winding 18 comprises a generator armature annular core 44 and a plurality of generator armature coils 42. The generator armature annular core 44 comprises a plurality of laminations in this example.

The AC exciter armature current is rectified by a rectifier assembly 80, described in more detail below, creating a DC generator field current in this example. The generator field current flows through the generator field coils 40, creating a static generator field magnetic field. Since the generator field coils 40 are part of the rotor 12 which rotates about a rotor axis 17, the generator field magnetic field itself rotates about the rotor axis. The generator field magnetic field changes over time and space with respect to the generator armature coils 42 on the stator 26. This induces an AC generator armature voltage in the generator armature coils 42 which can be applied to an AC load, or rectified into a DC generator armature voltage and applied to a DC load. In other embodiments, the exciter armature AC current is not rectified, but instead is applied directly to the generator field coils 40, which creates an alternating generator field magnetic field.

Also illustrated in FIG. 2 is a rotor mounting member 22 connected to the rotor housing 28. The rotor mounting member 22 extends radially inwardly from the rotor housing 28, in this example, and is used to connect the rotor 12 to a rotatable member, e.g. a flywheel of an engine. In the present embodiment the rotor mounting member 22 is a rotor mounting flange.

The stator 26 includes a stator mounting member 13 located on an end 19 of the stator housing 10. The stator mounting member 13 extends radially outwardly from the stator housing 10 in this example, and is used to connect the stator 26 to a stationary member, for example an engine block of the engine. The stator mounting member 13 is a stator mounting flange in the present embodiment.

The stator 26 also includes a stator windings mounting member 11 located on an end 21 of the stator housing 10 opposite end 19. The stator windings mounting member 11 extends radially inwardly from the stator housing 10, in this example, and is used to connect the end member 23 along with the central member 21 and the stator windings 18 and 20 to the stator housing 10. In the present embodiment, the stator windings mounting member 11 is a stator windings mounting flange.

In this example the rectifier assembly 80, illustrated in FIG. 2, is mounted on the inside of the rotor 12 between the exciter armature winding 14 and the generator field winding 16. However, in other embodiments the rectifier assembly 80 may be mounted in other locations, such as next to the stator windings mounting member 11, or next to the rotor mounting member 22. The rectifier assembly 80 in this example includes two bridge rectifiers and a termination assembly. The bridge rectifiers are located 120 degrees apart along an inner periphery of the rotor housing 28. The termination assembly is mounted equidistant from the two bridge rectifiers along the same periphery.

The rectifier assembly 80 is connected to the exciter armature coils 32 and to the generator field coils 40. It operates to rectify the AC exciter armature current into the DC generator field current.

The inside-out geometry of the present embodiment provides many advantages. It allows for elimination of a generator shaft and generator bearing. The relatively large diameter of the rotor mounting member 22, in this case a flange, results in very good structural strength. This eliminates the need for an outboard support bearing, as is commonly known in the art, and permits a cantilevered design as described above.

A high rotational inertia is also achieved with the inside-out geometry. This fulfills a need that exists when the generator is used on small diesel engines. Since the rotor 12 lies radially outwardly of the stator windings 18 and 20, it has the necessary rotational inertia for small diesel engines without adding excessive weight.

Another advantage of the inside-out geometry is its thermal characteristic. The location of the generator field winding 16 around an inner periphery of the rotor housing 28, next to the stator housing 10, provides significantly more cooling surface than if it was located radially within the stator windings 18 and 20. The generator field winding 16 can expel its heat losses to the surrounding stator housing 10. Additionally, the inside-out geometry allows for air ventilation openings in the rotor 12 to allow for some passive circulation of air in and around the rotor windings 14 and 16 to provide cooling.

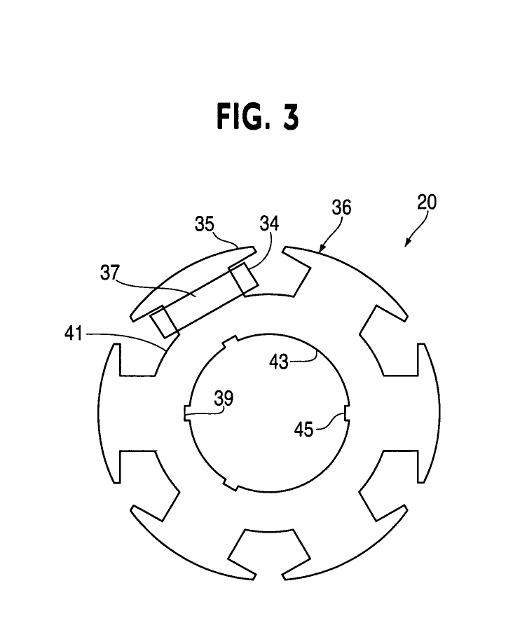

The exciter field winding 20 is now described in more detail. FIG. 3 shows an end view of the exciter field winding 20. The exciter field winding 20 includes the exciter field annular core 36 which has a plurality of radially outwardly extending members 37. In this example, each member 37 is symmetrical and extends from an outside annular surface 41 of the annular core 36. Each member 37 has a pair of lateral projections 35, in this example. The pair of lateral projections 35 are also known as pole tips. In other embodiments the member 37 can be asymmetrical having a single lateral projection. One of the exciter field coils 34 is mounted on each of the members 37. Only one of these coils is illustrated in FIG. 3, similar coils being mounted on the other five members in this example.

The exciter field annular core 36 has a plurality of notches 39, three in this example, and a projection 45 on an inner annular surface 43. The notches 39 and projection 43 provide alignment between the annular core 36 and the central member 21, which has complementary projections and notch, and serve to carry the torque that is present between the annular core and the central member during operation.

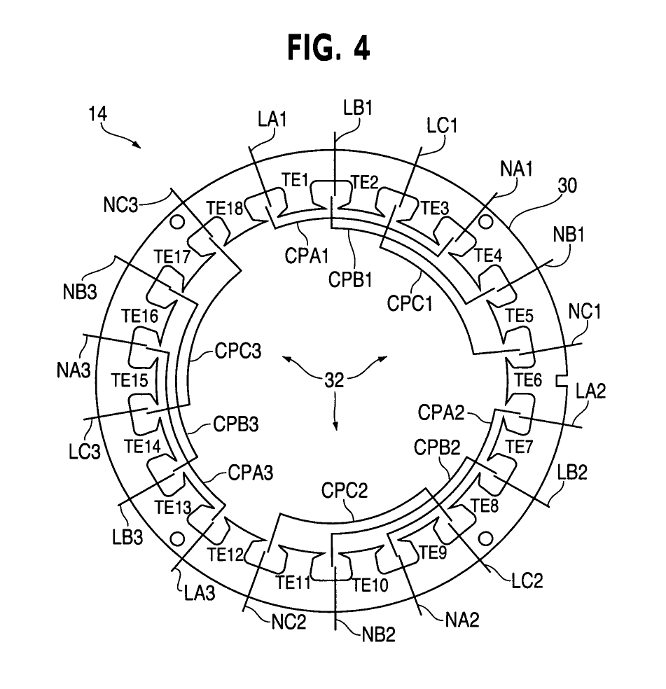

The exciter armature winding 14 is now described in more detail. Referring to FIG. 4, this illustrates an end view of the exciter armature annular core 30 having a plurality of exciter armature projections indicated generally by reference characters TE1 through TE18. In this example, the plurality of exciter armature coils 32 includes three coils per phase for a total of nine coils, indicated generally by reference characters CPA1, CPA2 and CPA3 for phase A, CPB1, CPB2 and CPB3 for phase B, and CPC1, CPC2 and CPC3 for phase C. This example exemplifies a one coil side per slot arrangement. In other embodiments there can be a different number of exciter armature coils 32, for example, a two coil side per slot arrangment. The exciter armature coils 32 in the same phase are connected in parallel in this example, however they can be connected in series, or in series-parallel combinations or in groups of parallel connections with coils in a group being connected in series-parallel combinations. Each of the exciter armature coils 32 spans three exciter armature projections, e.g. the exciter armature coil CPA1 spans exciter armature projections TE1 through TE4, as illustrated schematically by way of example only in FIG. 4.

The phase A coils CPA1, CPA2 and CPA3 have corresponding phase leads LA1, LA2 and LA3 and neutral connections NA1, NA2 and NA3 respectively. The phase leads LA1, LA2 and LA3 are connected together to form the phase A lead which is brought out of the electrical generator 31. The neutral connections are connected together and remain internal to the electrical generator 31. The phase B coils CPB1, CPB2 and CPB3 have corresponding phase leads LB1, LB2 and LB3 and neutral connections NB1, NB2 and NB3 respectively. The phase leads LB1, LB2 and LB3 are connected together to form the phase B lead which is brought out of the electrical generator 31. The neutral connections are connected together and remain internal to the electrical generator 31. The phase C coils CPC1, CPC2 and CPC3 have corresponding phase leads LC1, LC2 and LC3 and neutral connections NC1, NC2 and NC3 respectively. The phase leads LC1, LC2 and LC3 are connected together to form the phase C lead which is brought out of the electrical generator 31. The neutral connections are connected together and remain internal to the electrical generator 31.

The generator field winding 16 is now described in more detail. FIG. 5 shows an end view of the generator field winding 16. The generator field winding 16 includes the generator field annular core 38 having a plurality of inwardly extending asymmetric members indicated generally by reference numeral 52. The asymmetric members 52 are also known as asymmetric magnetic pole tips. The generator field annular core 38 lies in a plane corresponding to the illustration in FIG. 5. Each member 52 is located in the plane and extends from an inside annular surface 50 of the annular core 38. Each member 52 has a first side 54, a second side 56 and an end 58. The first side 54 and the second side 56 project radially inwardly from the surface 50 towards the end 58. Furthermore, each member 52 has a lateral projection 60 in the plane and which extends from the first side 54 near the end 58. One of the generator field coils 40 is mounted on each of the members 52. Only one of these coils is illustrated in FIG. 5, similar coils being mounted on the other seven members.

The generator field annular core 38 also has a notch 53 along an outer surface 55. The notch 53 is for aligning the annular core 38 with a complementary projection on the rotor housing 28 during assembly of the rotor 12, and serves to carry the torque that is present between the annular core and the rotor housing during operation.

The asymmetric member 52 allows the generator field coils 40 to be preformed and then mounted on the generator field annular core 38. This has many advantages including decreased manufacturing cost due to a reduction in manufacturing time and complexity of the generator field winding 16. Since the coils 40 may be preformed before being mounted on the cores 38, they can be wound by a machine. Machine wound coils have individual coil loops that are tightly spaced, as opposed to manually wound coils. This increases the number of turns in each coil thus increasing an ampere-turns per pole which correspondingly increases the magnetic field strength of the pole. The generator field coils 40 can also be machine wound directly onto the members 52 of the annular core 38.

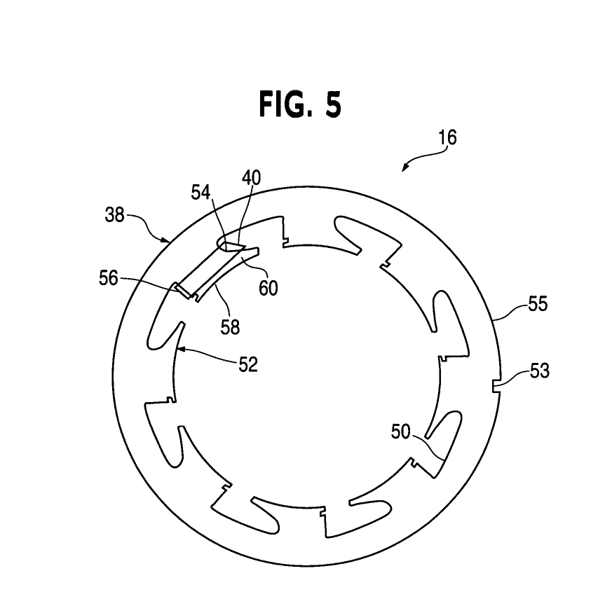

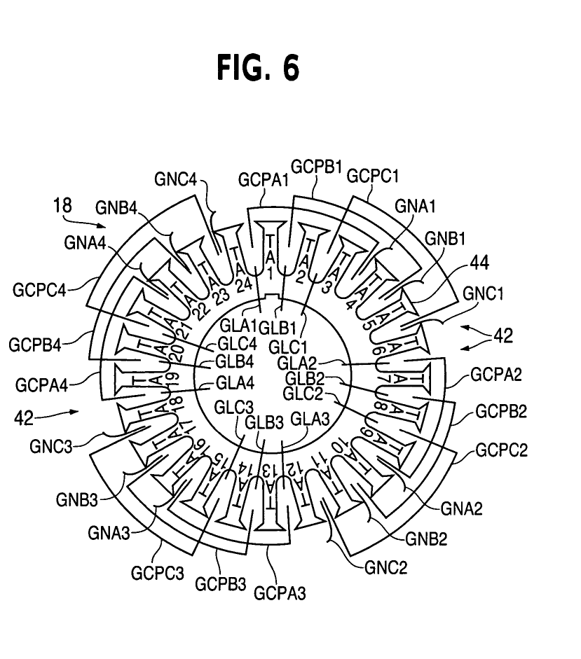

The generator armature winding 18 is now described in more detail. Referring to FIG. 6, this illustrates an end view of the generator armature annular core 44 having a plurality of exciter armature projections indicated generally by reference characters TA1 through TA24. In this example, the plurality of generator armature coils 42 includes four coils per phase for a total of twelve coils, indicated generally by reference characters GCPA1, GCPA2, GCPA3 and GCPA4 for phase A, GCPB1, GCPB2, GCPB3 and GCPB4 for phase B, and GCPC1, GCPC2, GCPC3 and GCPC4 for phase C. This example exemplifies a one coil side per slot arrangement. In other embodiments there may be a different number of generator armature coils 42, for example a two coil side per slot arrangement. The generator armature coils 42 in the same phase are connected in parallel in this example, however they can be connected in series, or in series-parallel combinations or in groups of parallel connections with coils in a group being connected in series-parallel combinations. Each of the generator armature coils 42 spans four generator armature projections, e.g. the generator armature coil GCPA1 spans generator armature projections TA1 through TA4, as illustrated schematically by way of example only in FIG. 6.

The phase A coils GCPA1, GCPA2, GCPA3 and GCPA4 have corresponding phase leads GLA1, GLA2, GLA3 and GLA4 and neutral connections GNA1, GNA2, GNA3 and GNA4 respectively. The phase leads GLA1, GLA2, GLA3 and GLA4 are connected together to form the phase A lead which is brought out of the electrical generator 31. The neutral connections are connected together and remain internal to the electrical generator 31. The phase B coils GCPB1, GCPB2, GCPB3 and GCPB4 have corresponding phase leads GLB1, GLB2, GLB3 and GLB4 and neutral connections GNB1, GNB2, GNB3 and GNB4 respectively. The phase leads GLB1, GLB2, GLB3 and GLB4 are connected together to form the phase B lead which is brought out of the electrical generator 31. The neutral connections are connected together and remain internal to the electrical generator 31. The phase C coils GCPC1, GCPC2, GCPC3 and GCPC4 have corresponding phase leads GLC1, GLC2, GLC3 and GLC4 and neutral connections GNC1, GNC2, GNC3 and GNC4 respectively. The phase leads GLC1, GLC2, GLC3 and GLC4 are connected together to form the phase C lead which is brought out of the electrical generator 31. The neutral connections are connected together and remain internal to the electrical generator 31.

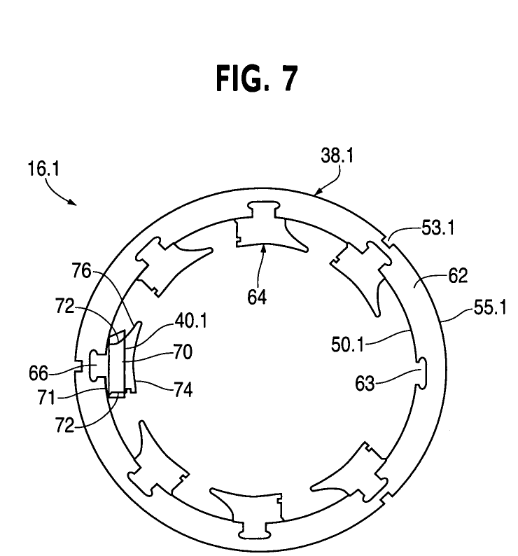

Another embodiment of the present invention is illustrated in FIG. 7, where like parts have like reference numerals appended by “0.1”. This embodiment is similar to the previous embodiment with differences as follows. A generator field winding 16.1 comprises an annular core 38.1, a plurality of modular winding members 64 and a plurality of generator field coils 40.1. The annular core 38.1 lies in a plane corresponding to the illustration of FIG. 7. The annular core 38.1 has a side surface 62 and an inside annular surface 50.1. The inside annular surface 50.1 has a plurality of recesses 63 extending from the side surface 62. One such recess 63 is illustrated in FIG. 7, the remaining recesses are shown engaged with the said winding members 64.

Each said winding member 64 lies in the plane and has a protrusion 66 and a body 70. The protrusion 66 is mutually engageable with the recess 63, and in this example the protrusion and recess form what is known as a dovetail. The body 70 has a pair of sides 72 and an end 74. The body 70 extends from the protrusion 66, along the pair of sides 72, towards the end 74. A projection 76 extends from one of the pair of sides 72 near the end 74. One of the generator field coils 40.1 is mounted on each of the members 64. Only one of these coils is illustrated in FIG. 7, similar coils being mounted on the other members.

The generator field annular core 38.1 also has a plurality of notches 53.1, three in this example, along an outer surface 55.1. The notches 53.1 provide alignment between the annular core 38.1 and complementary projections on the rotor housing 28, and serve to carry the torque that is present between the annular core and the rotor housing during operation.

The generator field coils 40.1 in this example are machine wound on the plurality of winding members 64, after which each said winding member 64 is engaged with one of said recesses 63 of the annular core 38.1. The advantages of this second embodiment of the generator field winding 16.1 are the same as the previous embodiment above. Furthermore, the annular core 38.1 can comprise either solid core technology or laminations.

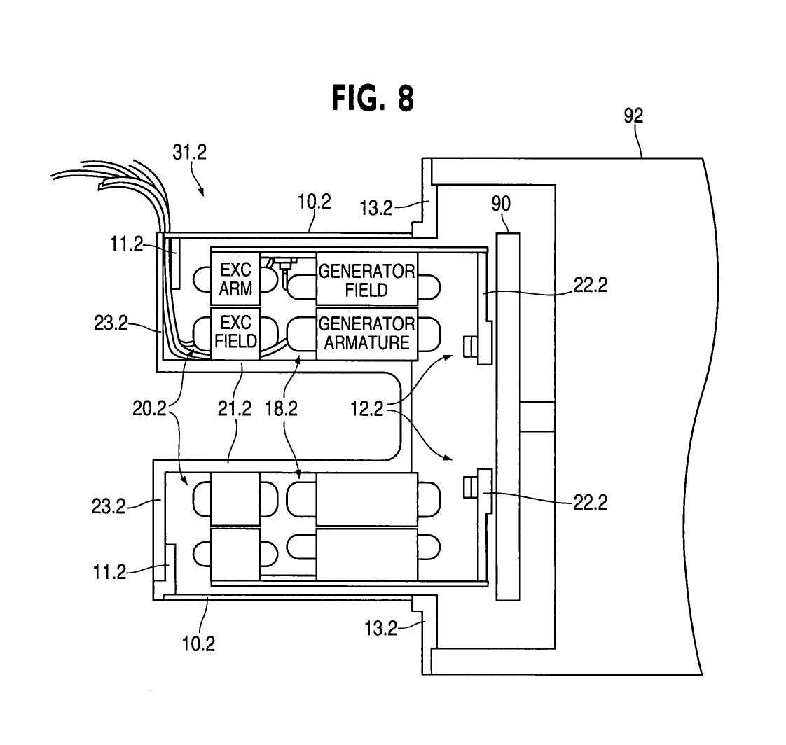

In another embodiment of the present invention illustrated in FIG. 8, wherein like parts have like reference numerals with the extension “0.2”, an electrical generator 31.2 is connected to a flywheel 90 and an engine block 92. The electrical generator 31.2 is similar to the electrical generator 31 of the prior embodiment. The flywheel 90 is a rotatable member for rotating the rotor. The engine block 92 is a stationary member for mounting the stator.

Another advantage of the present invention is the ability to quickly mount the electrical generator 31.2 on an engine or to remove therefrom. The electrical generator 31.2 is mounted on the engine by performing the following steps with reference to FIG. 8. A rotor 12.2 is aligned with the rotatable member, which in the present embodiment is the engine flywheel 90. A rotor mounting member 22 is connected to the engine flywheel 90, typically with bolts. A stator housing 10.2 is aligned with the stationary member, which in this embodiment is the engine block 92. A stator mounting member 13.2 is connected to the engine block 92, typically with bolts. An end member 23.2, including a central member 21.2, an exciter field winding 20.2 and a generator armature winding 18.2, is aligned with the stator windings mounting member 11.2. The end member 23.2 is connected to the stator windings mounting member 11.2, typically with bolts.

The removal procedure is the opposite to the mounting procedure. Note that after the end member 23.2 is removed from the stator housing 10.2, the rotor 12.2 can be removed from the rotatable member without removing the stator housing 10.2.

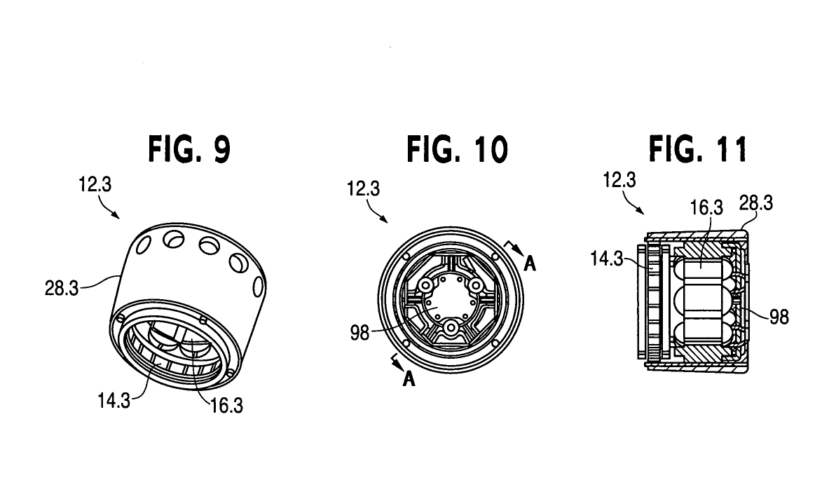

Another embodiment of the present invention is illustrated in FIGS. 9-14, wherein like parts have like reference numerals with the extension “0.3”. This embodiment is similar to the first embodiment. Referring first to FIGS. 9-11, there is shown a rotor 12.3 including an exciter armature winding 14.3, a generator field winding 16.3 and a rotor housing 28.3. A rectifier assembly 98 is connected to an end of the rotor 12.3. In this example, the rectifier assembly 98 includes two bridge rectifiers and a termination assembly mounted on a printed circuit board (PCB). The bridge rectifiers are located 120 degrees apart along an outer periphery of the PCB, the termination assembly is mounted equidistant from the two bridge rectifiers along the same periphery.

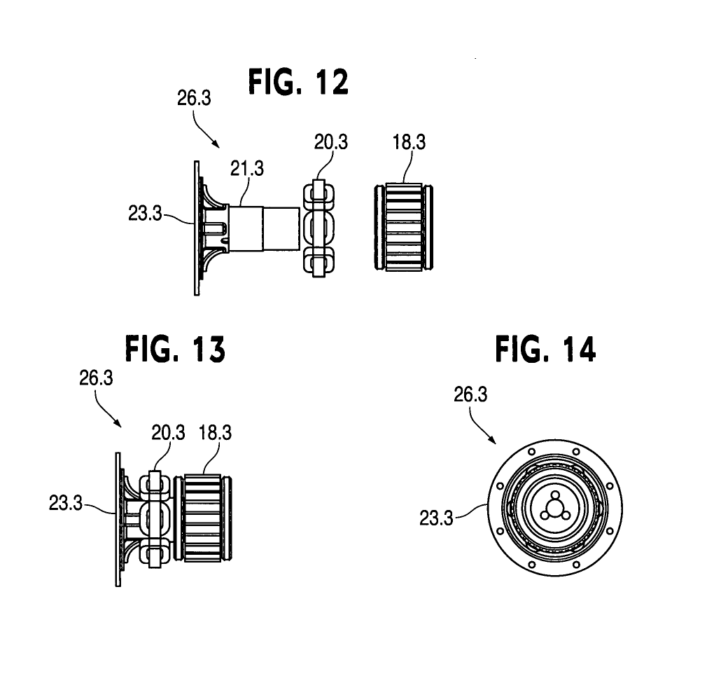

Now referring to FIGS. 12-14, there is shown a stator 26.3. The stator 26.3 includes a central member 21.3, an end member 23.3, an exciter field winding 20.3 and a generator armature winding 18.3.

An advantage of the rectifier assembly 98 is its convenient and accessible location for inspection and repair. Only the end member 23.3 needs to be removed from the electrical generator to provide access to the rectifier assembly 98.

As will be apparent to those skilled in the art, various modifications may be made within the scope of the appended claims.

What is claimed is:

1. An electrical generator comprising:
a stator having stator windings; and
an annular rotor having rotor windings extending about the stator windings.

2. The electrical generator as claimed in claim 1, wherein the rotor includes an annular rotor housing with an inside, the rotor windings being mounted in the inside of the rotor housing.

3. The electrical generator as claimed in claim 1, wherein the stator includes an end member with a central member extending therefrom, the stator windings being mounted on the central member.

4. The electrical generator as claimed in claim 3, wherein the stator includes an annular stator housing extending about the central member, the stator windings and the rotor.

5. The electrical generator as claimed in claim 4, wherein the stator housing is connected to the end member, the stator housing and the end member enclosing the rotor windings and the stator windings.

6. The electrical generator as claimed in claim 2, wherein the rotor housing has an end and a rotor mounting member on the end thereof.

7. The electrical generator as claimed in claim 6, wherein the rotor mounting member is a flange extending radially inwardly from the rotor housing.

8. The electrical generator as claimed in claim 5, wherein the stator housing includes a stator mounting member located at one end of the stator housing.

9. The electrical generator as claimed in claim 8, wherein the stator mounting member is a flange extending radially outwardly from the stator housing.

10. The electrical generator as claimed in claim 8, wherein the stator housing has a stator windings mounting member at an end of the stator housing opposite said one end.

11. The electrical generator as claimed in claim 10, wherein the stator windings mounting member is a flange extending radially inwardly from the stator housing.

12. The electrical generator as claimed in claim 1, wherein the stator windings comprise:
an exciter field winding having an exciter field core and exciter field coils; and
a generator armature winding having an generator armature core and generator armature coils.

13. The electrical generator as claimed in claim 12, wherein the rotor windings comprise:
an exciter armature winding having an exciter armature core and exciter armature coils; and
a generator field winding having a generator field core and generator field coils.

14. The electrical generator as claimed in claim 13, wherein the exciter armature winding is disposed radially outwardly from the exciter field winding.

15. The electrical generator as claimed in claim 13, wherein the generator field winding is disposed radially outwardly from the generator armature winding.

16. The electrical generator as claimed in claim 14, wherein the exciter armature winding is adjacent to the exciter field winding.

17. The electrical generator as claimed in claim 15, wherein the generator field winding is adjacent to the generator armature winding.

18. The electrical generator as claimed in claim 1, wherein the rotor windings include:
an annular core having an inside annular surface and a plurality of members, each said member having a first side, a second side and an end, the first side and second side projecting radially inwardly from the inside annular surface towards the end of said each member, said each member having a projection extending from the first side near the end of said each member.

19. The electrical generator as claimed in claim 1, wherein the rotor windings include:
an annular core having an inside annular surface and a side surface, the inside annular surface having a plurality of recesses extending from the side surface; and
a plurality of winding members, each said winding member having a protrusion, the protrusion being mutually engageable with each said recess.

20. The electrical generator as claimed in claim 19, wherein each said winding member further includes:
a body member having a pair of sides and an end, the body member extending from the protrusion, along the pair of sides, towards the end; and
a projection extending from one of the pair of sides near the end.

21. The electrical generator as claimed in claim 19, wherein each said winding member further includes:
a body member having an end, the protrusion extending outwardly from the end, the body member further including a pair of sides and an opposite end; and
a projection extending from one of the pair of sides near the end.

22. The electrical generator as claimed in claim 18, wherein the member is in a plane of the annular core.

23. The electrical generator as claimed in claim 18, wherein the projection is in a plane of the annular core.

24. The electrical generator as claimed in claim 19, wherein the winding member engages the annular core, the winding member being in a plane of the annular core.

25. The electrical generator of claim 18, wherein the annular core is laminated.

26. The electrical generator as claimed in claim 19, wherein the annular core is laminated.

27. The electrical generator as claimed in claim 18, wherein the annular core is solid.

28. The electrical generator as claimed in claim 19, wherein the annular core is solid.

29. The electrical generator as claimed in claim 1, wherein the electric generator is a DC electric generator.

30. The electrical generator as claimed in claim 1, wherein the electric generator is brushless.

31. The electrical machine as claimed in claim 2, wherein the rotor housing is cylindrical.

32. In combination, an engine and an electrical generator comprising:
a stator having stator windings, the stator being mounted on a stationary member; and
an annular rotor having rotor windings extending about the stator windings, the rotor being mounted to a rotatable member.

33. The combination as claimed in claim 32, wherein the rotor includes an annular rotor housing with an inside, the rotor windings being mounted in the inside of the rotor housing.

34. The combination as claimed in claim 33, wherein the stator includes an end member with a central member extending therefrom, the stator windings being mounted on the central member.

35. The combination as claimed in claim 32, wherein the stationary member is an engine block.

36. The combination as claimed in claim 32, wherein the rotatable member is a flywheel.

37. The electrical generator as claimed in claim 18, wherein the rotor winding is a generator field winding and wherein a coil is mounted on each said projection.

38. The electrical generator as claimed in claim 18, wherein the rotor winding is an exciter armature winding and wherein a coil is wound on at least two of said members, the coil being wound on said projection of each said member.

39. The electrical generator as claimed in claim 20, wherein the rotor winding is a generator field winding and wherein a coil is mounted on each said projection.

40. The electrical generator as claimed in claim 20, wherein the rotor winding is an exciter armature winding and wherein a coil is wound on at least two of said winding members, the coil being wound on said projection of each said winding member.

41. The electrical generator as claimed in claim 21, wherein the rotor winding is a generator field winding and wherein a coil is mounted on each said projection.

42. The electrical generator as claimed in claim 21, wherein the rotor winding is an exciter armature winding and wherein a coil is wound on at least two of said winding members, the coil being wound on said projection of each said winding member.

43. An electrical generator comprising:
a stator having an end member and a central member extending therefrom, the stator having stator windings, the stator windings being mounted on the central member;
an annular rotor having an inside and rotor windings, the rotor windings being mounted in the inside and extending about the stator windings; and
an annular stator housing extending about the central member, the stator windings and the rotor.

44. The electrical generator as claimed in claim 43, wherein the stator housing is connected to the end member, the stator housing and the end member enclosing the rotor windings and the stator windings.

45. The electrical generator as claimed in claim 43, wherein the rotor has an end and a rotor mounting member on the end thereof.

46. The electrical generator as claimed in claim 45, wherein the rotor mounting member is a flange extending radially inwardly from the rotor housing.

47. The electrical generator as claimed in claim 44, wherein the stator housing includes a stator mounting member located at one end of the stator housing.

48. The electrical generator as claimed in claim 47, wherein the stator mounting member is a flange extending radially outwardly from the stator housing.

49. The electrical generator as claimed in claim 47, wherein the stator housing has a stator windings mounting member at an end of the stator housing opposite said one end.

50. A method of mounting an electrical machine on an engine comprising the steps of:
aligning a rotor having rotor windings and a rotor mounting member with a flywheel;
connecting the rotor mounting member to the flywheel;
connecting a stator housing having a stator mounting member and a stator windings mounting member to an engine block, the stator housing enclosing the rotor; and
connecting an end member to the stator windings mounting member, the end member having a central member with stator windings mounted thereon.
